(19) United States
(12) Patent Application Publication
(10) Pub. No.: US 2013/0300351 A1
(43) Pub. Date: Nov. 14, 2013

(54) WIRELESS TRANSCEIVER AND WIRELESS TRANSCEIVER SYSTEM

(71) Applicant: PIXART IMAGING INC., Hsinchu County (TW)

(72) Inventors: Ren-Hau Gu, Hsinchu County (TW); Ming-Tsan Kao, Hsinchu County (TW); Sen-Huang Huang, Hsinchu County (TW)

(73) Assignee: PIXART IMAGING INC., Hsinchu County (TW)

(21) Appl. No.: 13/665,753

(22) Filed: Oct. 31, 2012

(30) Foreign Application Priority Data
May 11, 2012 (TW) 101116946

(51) Int. Cl. H02J 7/00; H01F 38/14

(52) U.S. Cl. 320/108; 307/104

(57) ABSTRACT

A wireless transceiver coupled to a human interface device (HID) having a first coil is provided. The wireless transceiver includes a control module, a port, and a second coil. The control module includes a radio frequency (RF) unit, a conversion unit, and an electricity power unit. The RF unit is used to receive a RF signal outputted from the HID.

The conversion unit coupled to the RF receiving unit is used to convert the RF signal to a data packet which is in accordance with the HID. The electricity power signal provides electricity power to the control module by the port. The electricity power unit drives the second coil according to the electricity power signal so that the second coil transmits an electromagnetic wave signal to the first coil of the HID by way of resonance and mutual inductance. Therefore, the wireless transceiver can charge to the HID wirelessly.

### CROSS-REFERENCE TO RELATED APPLICATIONS

This non-provisional application claims priority under 35 U.S.C. §119(a) on Patent Application No(s). 101116946 filed in Taiwan, R.O.C. on May 11, 2012, the entire contents of which are hereby incorporated by reference.

### BACKGROUND OF THE INVENTION

1. Technical Field

The disclosure relates to a transceiver and a transceiver system, and more particularly to a wireless transceiver and a wireless transceiver system.

2. Related Art

With rapid development of electronic technology and multimedia information, computer and computer interface device have become to be a part of people's daily life. Mouse as a computer interface device can be regarded as a bridge between a computer and a user.

Conventional mouse is connected to a computer by a wire, and thus a user's operation on the mouse is limited by the length of the wire. That is, the use convenience of the wired mouse is influenced by the length of the wire. In order to resolve the above problem, a wireless mouse has been designed. The wireless connection replacing the wired connection to the computer improves the use convenience of the mouse.

However, wireless mouse lacks wired connection to the computer and thus the problem of electricity power supply is needed to be considered. Generally, wireless mouse has batteries inside. When a user uses a wireless mouse with batteries inside, the electricity power may be used up during the use process if the user cannot make sure how much time is left for consuming the electricity power.

In order to resolve the above problems, a wireless mouse including magnet and coil has been developed. An induction current is generated by the relative movement between the magnet and the coil. The induction current is stored in the batteries for providing electricity power to the wireless mouse. This wireless mouse can resolve the problem of suddenly cutting off the electricity power supply because a user cannot make sure how much time is left for consuming the electricity power. However, the wireless mouse cannot be designed to be compact because of the size of the magnet and the coil.

### SUMMARY OF THE INVENTION

In one aspect, a wireless transceiver coupled to a human interface device (HID) is disclosed. The wireless transceiver is used to receive a radio frequency (RF) signal outputted from the HID which comprises a first coil. The wireless transceiver comprises a control module, a port through which an electricity power signal provides electricity power to the control module, and a second coil. The control module comprises a RF receiving unit for receiving the RF signal, a conversion unit coupled to the RF receiving unit for converting the RF signal to be a data packet which is in accordance with the HID, and an electricity power unit. The second coil is coupled to the electricity power unit. The electricity power unit drives the second coil according to the electricity power signal so that the second coil outputs an electromagnetic wave signal to the first coil by way of resonance and mutual inductance.

In another aspect, a wireless transceiver coupled to a human interface device (HID) is disclosed. The wireless transceiver is used to receive a radio frequency (RF) signal outputted from the HID having a first coil. The wireless transceiver comprises a second coil for receiving the RF signal, a control module, and a a port through which an electricity power signal provides electricity power to the control module so that the electricity power unit drives the second coil according to the electricity power signal and the second coil outputs an electromagnetic wave signal to the first coil by way of resonance and mutual inductance. The control module comprises a conversion unit and an electricity power unit coupled to the second coil. The conversion unit is coupled to the second coil for converting the RF signal received by the second coil to be a data packet which is in accordance with the HID.

In yet another aspect, a wireless transceiver system is disclosed. The wireless transceiver system comprises a wireless transceiver and a wireless charging device. The wireless transceiver is used to receive a radio frequency (RF) signal. The wireless transceiver comprises a control module, a port through which an electricity power signal provides electricity power to the control module, and a second coil. The control module comprises a RF receiving unit for receiving the RF signal, a conversion unit coupled to the RF receiving unit for converting the RF signal received by the RF receiving unit to be a data packet, and an electricity power unit. The second coil is coupled to the electricity power unit and is used to drive the second coil according to the electricity power signal so that the second coil outputs an electromagnetic wave signal. The wireless charging device comprises a movement detection module for calculating a displacement of the wireless charging device and a first coil coupled to the movement detection module for receiving and converting the electromagnetic wave signal to provide electricity power to the movement detection module.

In still another aspect, a wireless transceiver system is disclosed. The wireless transceiver system comprises a wireless transceiver and a wireless charging device. The wireless transceiver is used to receive a radio frequency (RF) signal. The wireless transceiver comprises a second coil for receiving the RF signal, a control module, and a port through which an electricity power signal provides electricity power to the control module so that the electricity power module drives the second coil according to the electricity power signal and the second coil outputs an electromagnetic wave signal. The control module comprises a conversion unit coupled to the second coil for converting the RF signal received by the second coil to be a data packet and an electricity power unit coupled to the second coil. The wireless charging device comprises a movement detection module for calculating a displacement of the wireless charging device and a first coil coupled to the movement detection module for receiving and converting the electromagnetic signal to provide electricity power to the movement detection module.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of a wireless transceiver system according to a first embodiment of the disclosure;

FIG. 2 is a block diagram of a wireless transceiver system according to a second embodiment of the disclosure;

FIG. 3 is a block diagram of a wireless transceiver system according to a third embodiment of the disclosure; and

FIG. 4 is a block diagram of a wireless transceiver system according to a fourth embodiment of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

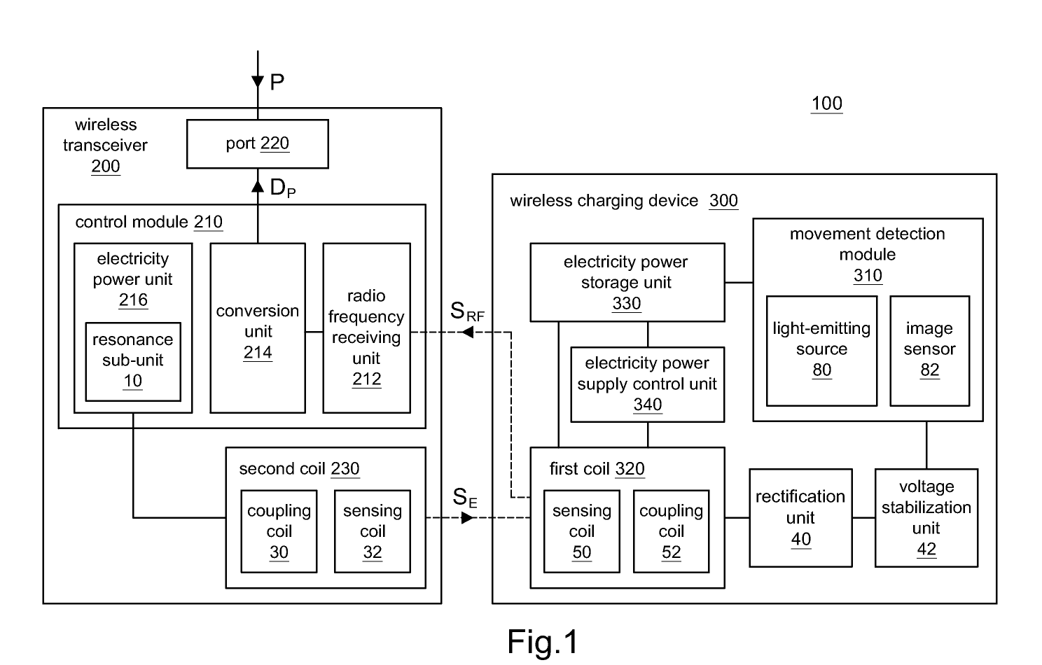

FIG. 1 is a block diagram of a wireless transceiver system according to a first embodiment of the disclosure. In this embodiment, the wireless transceiver system 100 comprises a wireless transceiver 200 and a wireless charging device 300. The wireless transceiver 200 comprises a control module 210, a port 220, and a second coil 230. The control module 210 comprises a radio frequency (RF) receiving unit 212, a conversion unit 214, and an electricity power unit 216. The conversion unit 214 is coupled to the RF receiving unit 212, and the second coil unit 230 is coupled to the electricity power unit 216. The wireless charging device 300 comprises a movement detection module 310 and a first coil 320 which is coupled to the movement detection module 310. The wireless charging device 300 may be a wireless mouse. The port 220 may be a Universal Serial Bus (USB). The movement detection module 310 comprises at least a light-emitting source 80 and an image sensor 82. In other words, the wireless charging device 300 may be a wireless charging optical mouse. The light of the at least one light-emitting source 80 is projected onto a working plane which is for example but not limited the surface of a desk. The image sensor 82 catches images of the light projected on the working plane at different time points. The movement detection module 310 performs a movement detection calculation based on the images sensed by the imager sensor 82 and obtains the displacement of the wireless charging device 300.

The RF receiving unit 212 is used to receive the RF signal S_{RF}. The conversion unit 214 is used to convert the RF signal S_{RF} to be the data packet Dp and transmit the data packet Dp to the computer (not shown in FIG. 1) connected to the port 220. The wireless transceiver 200 is coupled to the computer by the port 220, and thus the port 220 can receive an electricity power signal P from the computer and then provide the electricity power to the control module 210. The electricity power unit 216 drives the second coil 230 according to the electricity power signal P so that the second coil 230 outputs an electromagnetic wave signal S_{E} to the first coil 320 of the wireless charging device 300. The first coil 320 receives and converts the electromagnetic wave signal S_{E} and provides electricity power to the movement detection module 310 (i.e., the light-emitting source 80 and the image sensor 82). The movement detection unit 310 is used to calculate the displacement of the wireless charging device 300 and send the RF signal S_{RF} to the RF receiving unit 212.

In addition, the electricity power unit 216 may further comprise a resonance sub-unit 10. The second coil 230 may further comprise a coupling coil 30 and a sensing coil 32. The electricity power unit 216 uses the resonance sub-unit 10 to drive the coupling coil 30 based on the electricity power signal P so that the coupling coil 30 generates a magnetic field and is coupled to the sensing coil 32. As a result, the sensing coil 32 outputs the electromagnetic wave signal S_{E} to the first coil 320 of the wireless charging device 300 by way of resonance and mutual inductance. The wireless charging device 300 may further comprise a rectification unit 40 and a voltage stabilization unit 42. The first coil 320 comprises a sensing coil 50 and a coupling coil 52. The sensing coil 50 receives the electromagnetic wave signal S_{E} to generate a magnet field and is coupled to the coupling coil 52 so that the coupling coil 52 outputs an alternating current (AC). The rectification unit 40 is used to rectify the AC outputted from the coupling coil 52 and output the rectified AC to the voltage stabilization unit 42. The voltage stabilization unit 42 stabilizes the rectified AC and provides electricity power to the movement detection module 310.

More particularly, the wireless transceiver 200 receives the electricity power signal P from the computer by the port 220, where P is a Direct Current (DC) signal. The electricity power unit 216 converts the DC signal (i.e., the electricity power signal P) into an AC signal. The resonance sub-unit 10 generates an alternating magnetic field based on the AC signal. The alternating magnetic field drives the coupling coil 30 so that he the coupling coil 30 generates the magnetic field and is coupled to the sensing coil 32. As a result, the sensing coil 32 outputs the electromagnetic wave signal S_{E} to the first coil 320 of the wireless charging device 300 by way of resonance and mutual inductance.

The sensing coil 50 of the wireless charging device 300 receives the electromagnetic wave signal S_{E} and generates a magnet field. The sensing coil 50 is coupled to the coupling coil 52 so that the coupling coil 52 outputs the AC signal. The rectification unit 40 is used to rectify the AC signal outputted from the coupling coil 52 and output the rectified AC signal to the voltage stabilization unit 42. The voltage stabilization unit 42 stabilizes the rectified AC and provides electricity power to the movement detection module 310. After obtaining the electricity power, the movement detection module 310 calculates the displacement of the wireless charging device 300, generates the RF signal S_{RF} based on the displacement, and sends the RF signal S_{RF} to the RF receiving unit 212 of the wireless transceiver 200. The conversion unit 214 is used to convert the RF signal S_{RF} received by the RF receiving unit 212 to the data packet Dp and send Dp to the computer connected to the port 220. The computer performs a data processing on the data packet Dp to obtain the displacement of the wireless charging device 300, and further controls the displacement of the cursor on the computer screen.

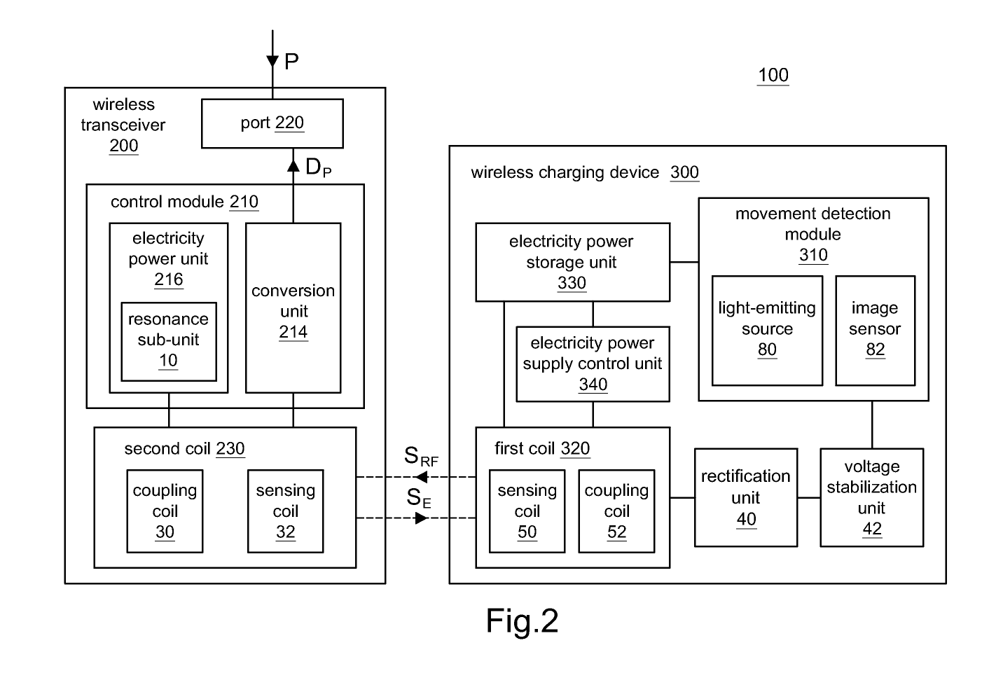

FIG. 2 is a block diagram of a wireless transceiver system according to a second embodiment of the disclosure. The difference between the second embodiment and the first embodiment is that the wireless transceiver 200 in the second embodiment does not use a RF receiving unit 212 to receive the RF signal S_{RF} outputted from the wireless charging device 300. Instead, the wireless transceiver 200 uses the second coil 230 to receive the RF signal S_{RF}.

More particularly, the wireless transceiver 200 receives the electricity power signal P from the computer by the port 220, where P is a Direct Current (DC) signal. The electricity power unit 216 converts the DC signal (i.e., the electricity power signal P) into an AC signal. The resonance sub-unit 10 generates an alternating magnetic field based on the AC signal. The alternating magnetic field drives the coupling coil 30 so that he the coupling coil 30 generates the magnetic field and is coupled to the sensing coil 32. As a result, the sensing coil 32 outputs the outputs the electromagnetic wave signal S_{E} by way of resonance and mutual inductance to the first coil 320 of the wireless charging device 300.

The sensing coil 50 of the wireless charging device 300 receives the electromagnetic wave signal S_{E} and generates a magnet field. The sensing coil is coupled to the coupling coil 52 so that the coupling coil 52 outputs the AC signal. The rectification unit 40 is used to rectify the AC signal outputted from the coupling coil 52 and output the rectified AC signal to the voltage stabilization unit 42. The voltage stabilization unit 42 stabilizes the rectified AC and provides electricity power to the movement detection module 310. After obtaining the electricity power, the movement detection module 310 calculates the displacement of the wireless charging device 300, generates the radio frequency signal S_{RF} based on the displacement, and sends the radio frequency signal S_{RF} to the sensing coil 32 of the wireless transceiver 200. The conversion unit 214 is used to convert the RF signal S_{RF} received by the sensing coil 32 to the data packet Dp and send Dp to the computer connected to the port 220. The computer performs a data processing on the data packet Dp to obtain the displacement of the wireless charging device 300, and further controls the displacement of the cursor on the computer screen.

It should be noted that the second coil 230 may receive the RF signal S_{RF} and send the electromagnetic wave signal S_{E} at the same time. Thus, to achieve this aim, the frequencies of the radio frequency signal S_{RF} and the electromagnetic wave signal S_{E} can be adjusted (i.e., the frequency of the radio frequency signal S_{RF} is adjusted to be different from that of the electromagnetic wave signal S_{E}). In this case, the wireless charging optical mouse can detect the displacement of the mouse to control the cursor at the same time when receiving the electromagnetic wave signal to finish the charging. Therefore, the electricity power supply to the mouse cannot be suddenly cut off.

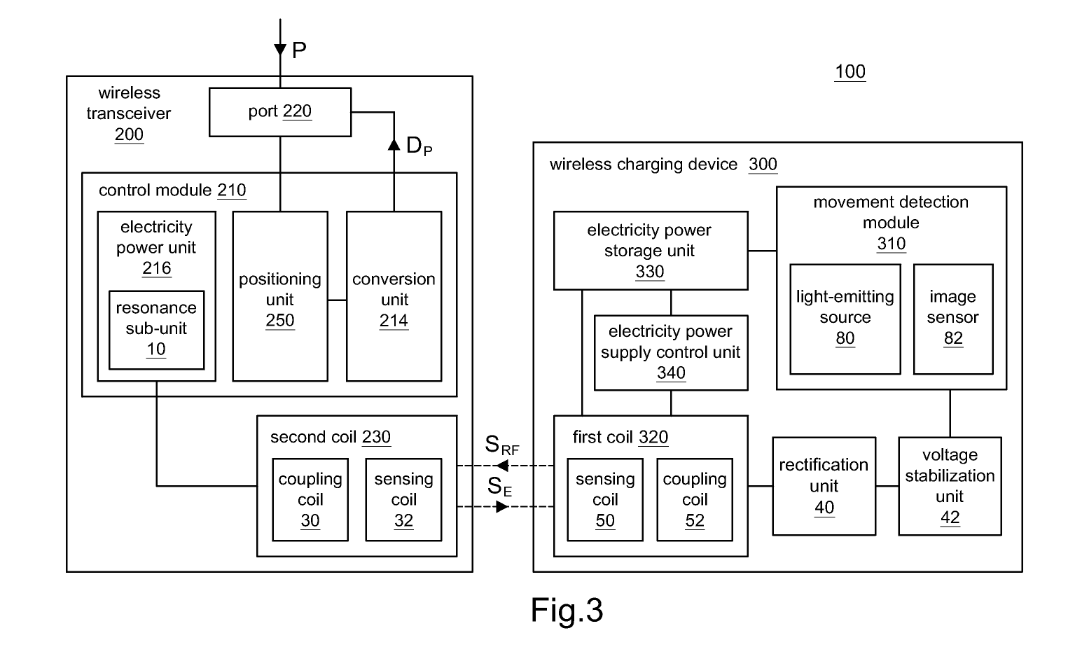

FIG. 3 is a block diagram of a wireless transceiver system according to a third embodiment of the disclosure. The difference between the third embodiment and the second embodiment is that the wireless transceiver 200 of the third embodiment further comprises a positioning unit 250. The positioning unit 250 is used to adjust the position (angle) of the second coil 230 according to the RF signal S_{RF} received by the second coil 230. As a result, the receiving rate for receiving the electromagnetic wave signal S_{E} by the first coil 320 can be improved.

More particularly, the wireless transceiver 200 receives the electricity power signal P from the computer by the port 220, where P is a Direct Current (DC) signal. The electricity power unit 216 converts the DC signal (i.e., the electricity power signal P) into an AC signal. The resonance sub-unit 10 generates an alternating magnetic field based on the AC signal. The alternating magnetic field drives the coupling coil 30 so that he the coupling coil 30 generates the magnetic field and is coupled to the sensing coil 32. As a result, the sensing coil 32 outputs the outputs the electromagnetic wave signal S_{E} by way of resonance and mutual inductance to the first coil 320 of the wireless charging device 300.

The sensing coil 50 of the wireless charging device 300 receives the electromagnetic wave signal S_{E} and generates a magnet field. The sensing coil is coupled to the coupling coil 52 so that the coupling coil 52 outputs the AC signal. The rectification unit 40 is used to rectify the AC signal outputted from the coupling coil 52 and output the rectified AC signal to the voltage stabilization unit 42. The voltage stabilization unit 42 stabilizes the rectified AC and provides electricity power to the movement detection module 310. After obtaining the electricity power, the movement detection module 310 calculates the displacement of the wireless charging device 300, generates the RF signal S_{RF} based on the displacement, and sends the RF signal S_{RF} to the sensing coil 32 of the wireless transceiver. The conversion unit 214 is used to convert the RF signal S_{RF} received by the sensing coil 32 to the data packet Dp and send Dp to the computer connected to the port 220. The computer performs a data processing on the data packet Dp to obtain the displacement of the wireless charging device 300, and further controls the displacement of the cursor on the computer screen.

When the computer obtains the displacement of the wireless charging device 300, the computer may adjust the position (angle) of the second coil 230 by the positioning unit 250 so as to improve the magnetic flux density of the first coil 320 and the receiving rate for receiving the electromagnetic wave signal S_{E} by the first coil 320. Because the optical mouse in use is not at a fixed position, the positions of the mouse can be tracked based on the positioning function of the disclosure. Moreover, the charged electricity power can be transmitted to the optical mouse more accurately.

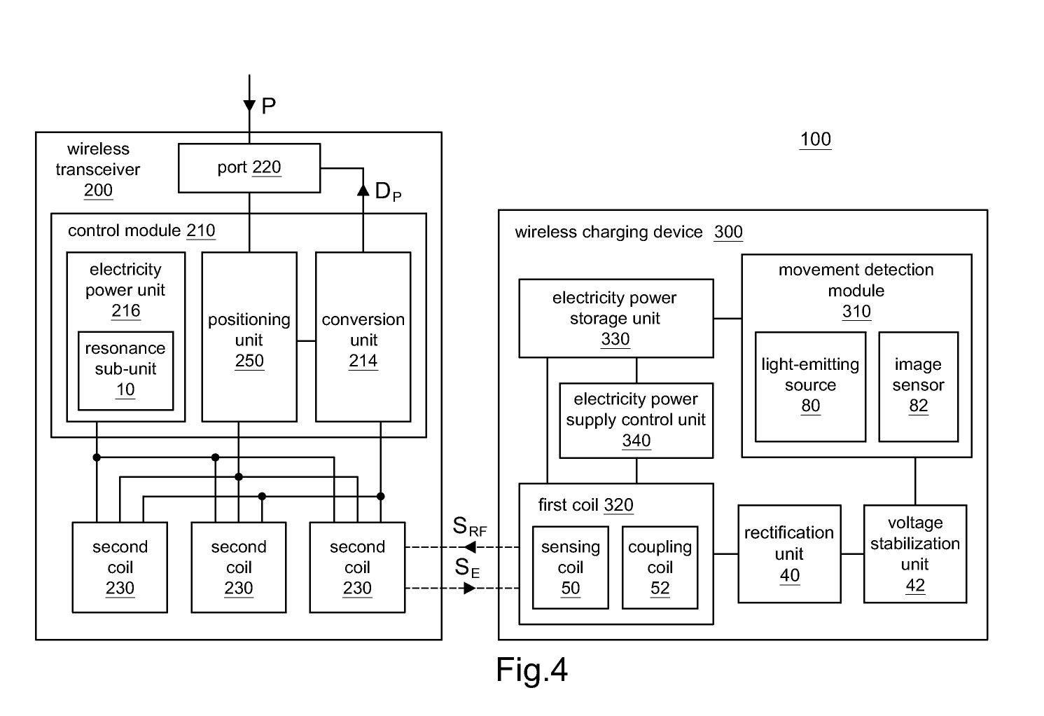

In the third embodiment, the positioning unit 250 adjusts the position (angle) of the second coil 230 to improve the receiving rate for receiving the electromagnetic wave signal S_{E} by the first coil 320, but the disclosure is not limited by the embodiment. For example, FIG. 4 is a block diagram of a wireless transceiver system according to a fourth embodiment of the disclosure. The difference between the fourth embodiment and the third embodiment is that there are a plurality of second coils in the fourth embodiment. Each of the second coils is coupled to the positioning unit 250 and has different positions (angle). Therefore, when the computer obtains the displacement of the wireless charging device 300, in order to increase the magnetic flux density of the first coil 320, the computer selects to drive at least one second coil 230 by the positioning unit 250, and as a result the receiving rate for receiving the electromagnetic wave signal S_{E} by the first coil 320 can be improved.

In addition, when the first coil 320 obtains the electricity power by converting the electromagnetic wave signal S_{E}, the movement detection module 310 may not perform the displacement calculation of the wireless charging device 300. In this case, the wireless charging device 300 according to embodiment of FIG. 1, 2, 3, or 4 may further comprise an electricity power storage unit 330 for storing the electricity power obtained by converting the electromagnetic wave signal S_{E.} The stored electricity power can be provided to the movement detection module 310 to perform the displacement calculation of the wireless charging device 300.

Furthermore, the wireless charging device 300 may further comprise an electricity power supply control unit 340 which is coupled to the electricity power storage unit 330 and the first coil 320. The electricity power supply control unit 340 is used to drive the first coil 320 according to the electricity power storage quantity so as to transmit the electricity power quantity signal to the wireless transceiver 200. Based on the electricity power storage quantity signal, the wireless transceiver 200 determines whether the second coil 230 outputs the electromagnetic wave signal S_{E} to ensure that the electricity power storage unit 330 has enough electricity power quantity to provide to the movement detection module 310 for the displacement calculation.

Based on the above, the embodiments of the wireless transceiver and wireless transceiver system perform wireless charging to a human interface device (HID) or a wireless charging device and receive data outputted from the HID or the wireless charging device. The second coil of the wireless transceiver transmits the electromagnetic wave signal to the first coil of the HID or the wireless charging device by way of resonance and mutual inductance, so that the first coil converts the electromagnetic wave signal to provide electricity power to the HID or the wireless charging device. The second coil of the wireless transceiver is used to receive the displacement data outputted from the HID or the wireless charging device. In addition, the second coil may receive the radio frequency signal and transmit the electromagnetic wave signal at the same time by for example adjusting the frequencies of the radio frequency signal and the electromagnetic wave signal (i.e., the frequency of the radio frequency signal is different from that of the electromagnetic wave signal). Furthermore, a positioning unit and a plurality of second coils having different positions may be designed so that the positioning unit may adjust the position of the second coil. Thus, the magnetic flux density of the first coil and the receiving rate for receiving the electromagnetic wave signal can be improved.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. A wireless transceiver coupled to a human interface device (HID) for receiving a radio frequency (RF) signal outputted from the HID, the HID comprising a first coil, the wireless transceiver comprising:
a control module, comprising
a RF receiving unit for receiving the RF signal;
a conversion unit coupled to the RF receiving unit for converting the RF signal to be a data packet, and the data packet being in accordance with the HID; and
an electricity power unit;
a port through which an electricity power signal provides electricity power to the control module; and
a second coil coupled to the electricity power unit, the electricity power unit driving the second coil according to the electricity power signal so that the second coil outputs an electromagnetic wave signal to the first coil by way of resonance and mutual inductance.

2. A wireless transceiver coupled to a human interface device (HID) for receiving a radio frequency (RF) signal outputted from the HID, the HID comprising a first coil, the wireless transceiver comprising:
a second coil for receiving the RF signal;
a control module, comprising
a conversion unit coupled to the second coil for converting the RF signal received by the second coil to be a data packet, and the data packet being in accordance with the HID; and
an electricity power unit coupled to the second coil; and
a port through which an electricity power signal provides electricity power to the control module, so that the electricity power unit drives the second coil according to the electricity power signal and the second coil outputs an electromagnetic wave signal to the first coil by way of resonance and mutual inductance.

3. The wireless transceiver according to claim 2, wherein the control module further comprising a positioning unit coupled to the second coil, the positioning unit being used to adjust a position of the second coil according to the RF signal received by the second coil so as to improve a receiving rate for receiving the electromagnetic wave signal by the first coil.

4. The wireless transceiver according to claim 2, wherein the control module further comprising a plurality of the second coils and a positioning unit, each of the second coils being coupled to the positioning unit, the positioning unit being used to selectively drive one of the second coils according to the RF signal so as to improve a receiving rate for receiving the electromagnetic wave signal by the first coil.

5. A wireless transceiver system, comprising:
a wireless transceiver for receiving a radio frequency (RF) signal, the wireless transceiver comprising
a control module, comprising
a RF receiving unit for receiving the RF signal;
a conversion unit coupled to the RF receiving unit for converting the RF signal received by the RF receiving unit to be a data packet; and
an electricity power unit;
a port through which an electricity power signal provides electricity power to the control module; and
a second coil coupled to the electricity power unit, and the electricity power unit driving the second coil according to the electricity power signal so that the second coil outputs an electromagnetic wave signal; and
a wireless charging device, comprising
a movement detection module for calculating a displacement of the wireless charging device; and
a first coil coupled to the movement detection module for receiving and converting the electromagnetic wave signal to provide electricity power to the movement detection module.

6. The wireless transceiver system according to claim 5, wherein the wireless charging device further comprising an electricity power storage unit for storing electricity power obtained by the first coil converting the electromagnetic wave signal and providing the electricity power to the movement detection module.

7. The wireless transceiver system according to claim 6, wherein the wireless charging device further comprising an electricity power supply control unit coupled to the electricity power storage unit and the first coil, the electricity power supply control unit being used to drive the first coil according to the electricity power stored in the electricity power storage unit so as to transmit an electricity power quantity signal to the wireless transceiver, and the wireless transceiver being used to determine whether the second coil outputs the electromagnetic wave signal according to the electricity power quantity signal.

8. The wireless transceiver system according to claim 6, wherein the second coil being used to transmit the electromagnetic wave signal to the first coil by way of resonance and mutual inductance.

9. A wireless transceiver system, comprising:
a wireless transceiver for receiving a radio frequency (RF) signal, the wireless transceiver comprising
a second coil for receiving the RF signal;
a control module, comprising
a conversion unit coupled to the second coil for converting the RF signal received by the second coil to be a data packet; and
an electricity power unit coupled to the second coil; and
a port through which an electricity power signal provides electricity power to the control module, so that the electricity power module drives the second coil according to the electricity power signal and the second coil outputs an electromagnetic wave signal; and
a wireless charging device, comprising
a movement detection module for calculating a displacement of the wireless charging device; and
a first coil coupled to the movement detection module for receiving and converting the electromagnetic signal to provide electricity power to the movement detection module.

10. The wireless transceiver system according to claim 9, wherein the wireless transceiver system further comprising an electricity power storage unit for storing electricity power obtained by the first coil converting the electromagnetic wave signal and providing the electricity power to the movement detection module.

11. The wireless transceiver system according to claim 10, wherein the wireless charging device further comprising an electricity power supply control unit coupled to the electricity power storage unit and the first coil, the electricity power supply control unit being used to drive the first coil according to the electricity power stored in the electricity power storage unit so as to transmit an electricity power quantity signal to the wireless transceiver, and the wireless transceiver being used to determine whether the second coil outputs the electromagnetic wave signal according to the electricity power quantity signal.

12. The wireless transceiver system according to claim 9, wherein the control module further comprises a positioning unit coupled to the first coil, the positioning unit being used to adjust a position of the second coil according to the RF signal.

13. The wireless transceiver system according to claim 9, wherein the control module further comprises a plurality of the second coils and a positioning unit, each of the second coils being coupled to the positioning unit, the positioning unit being used to selectively drive one of the second coils according to the RF signal so as to improve a receiving rate for receiving the electromagnetic wave signal by the first coil.

14. The wireless transceiver system according to claim 9, wherein the second coil being used to transmit the electromagnetic wave signal to the first coil by way of resonance and mutual inductance.
